(19) United States
(12) Patent Application Publication
(10) Pub. No.: US 2013/0156248 A1
(43) Pub. Date: Jun. 20, 2013

(54) EAR SPEAKER

(71) Applicant: Terumasa Nakajima, Nagano-shi (JP)

(72) Inventor: Terumasa Nakajima, Nagano-shi (JP)

(73) Assignee: MK ELECTRONIC CO., LTD., Nagano-shi, Nagano (JP)

(21) Appl. No.: 13/818,302

(22) PCT Filed: Aug. 18, 2011
(86) PCT No.: PCT/JP2011/068668

§ 371 Date: Feb. 22, 2013

(30) Foreign Application Priority Data
Aug. 24, 2010 (JP) 2010-187010

(51) Int. Cl. H04R 1/10

(52) U.S. Cl. CPC H04R 1/1091
USPC 381/374

(57) ABSTRACT

Provided is an ear speaker that reduces the strain on the eardrums and reduces headphone deafness and, furthermore, can be safely used without isolating the user from surrounding sounds. The disclosed device consists of speakers (2R, 2L) that output an audio signal and are mounted in a position a set distance (S) from the ears of the user (P). The speakers (2R, 2L) are moveably attached to a headband (1) in such a manner that, when worn by the user (P), the speakers (2R, 2L) are directed at the ears of the user (P).

### TECHNICAL FIELD

The present invention relates to an ear speaker. The ear speaker is put on ears to privately enjoy music or such.

### BACKGROUND ART

As headphones for privately enjoying music by a portable audio player and the like, an overhead type that is put on so that the auricles are covered; an ear fitting type headphone that is put on the auricle; and an inner ear type headphone that is directly inserted in the ear hole have been known.

In recent years, there arises a problem concerning deafness (headphone deafness) due to listening to music over a long period of time utilizing such a headphone. In this connect, a headphone disclosed in Japanese Patent No. 3054295, which is the prior art of the present invention, has a speaker provided at a position out of a front side of a portion entering in the ear hole in order to avoid direct stimulation to the eardrum. However, similar to the overhead type headphone, the headphone disclosed therein covers the whole of the auricle with the ear pad so that a sound filed is formed in a space surrounded by the ear pad. Consequently, it is difficult for this ear speaker to hear the surrounding sound and, thus, the headphone disclosed therein has a problem in safety.

### PRIOR ART DOCUMENT

### Patent Document

Patent Document 1: Japanese Patent No. 3054295

### SUMMARY OF THE INVENTION

### Problem to be Solved by the Invention

The present invention is to provide an ear speaker, which reduces the deafness even if it is used over a long period of time, and which can be used in a safety manner without isolating the user from surrounding sound.

### Means for Solving Problem

The invention which solves the problem is an ear speaker having speakers, which output an audio signal, and a mounting part mounted in a position at a set distance from the ear hole of the user, wherein the speakers are movably attached to the mounting part in such a manner that, when the user wears the ear speaker, the speakers are directed at the both ear holes of the user, respectively.

The speakers each has a bullet form as a whole, the rear portion of which forms a hemispheric form or a hemi-spheroidal form, and the front portion of which is a flat surface equipped with a hood. Sound holes are formed on the flat surface of the front portion, and a sound absorbing material is provided within the inside of the hemispheric or hemi-spheroidal portion. The mounting part has an arch form band portion which is fit to the head of the user, wearing pads which are provided on both tips of the mounting part, and which are in contact with right and left temporal regions of the user to keep the wearing state, and ear hooks which are fixed to the left and right auricles of the user.

### EFFECT OF THE INVENTION

According to the present invention, since the speakers output sound from a set distance from inlets of the both ear holes, damage to the eardrum can be reduced, as a result, the ear speaker of the present invention can prevent the user from headphone deafness. Also, since the ear speaker of the present invention does not block the ear, the user can hear the surrounding sound, can enjoy audio playback in a safety manner, and there is no need for the user to speak loudly.

Furthermore, since the ear speaker of the present invention has a sound absorbing material provided within a housing of the speaker, sound is hardly leaked outside of the ear speaker. Also, since sonic wave reflected within the housing is effectively radiated from the front side, the deterioration of sound quality can be minimized. In addition, since the speakers are held on the head by means of the wearing pads, good fitting sense can be kept during the wear, the ear speaker is slipped off only with difficulty; as a result, the ear speaker has the effects that it is hard to be tired and, thus, that the ear is difficult to be stuffy, even if the user puts on the ear speaker of the present invention over a long period of the time.

### BRIEF DESCRIPTION OF THE DRAWINGS

FIG. 1 is a side view showing the situation of wearing the ear speaker of Embodiment 1 of the present invention.

FIG. 2 is a plane view showing the situation of wearing the ear speaker of Embodiment 1 of the present invention.

FIG. 3 is a rear view showing the situation of wearing the ear speaker of Embodiment 1 of the present invention.

FIG. 4 is an inner cross-sectional view of the speaker portion of FIG. 1.

FIG. 5A is a side view showing the situation of wearing the ear speaker of Embodiment 2 of the present invention.

FIG. 5B is a side view showing the situation of wearing the ear speaker of Embodiment 3 of the present invention.

FIG. 5C is a side view showing the situation of wearing the ear speaker of Embodiment 4 of the present invention.

FIG. 6 is a side view showing the situation of wearing the ear speaker of Embodiment 5 of the present invention.

### EMBODIMENTS FOR CARRYING OUT THE INVENTION

The embodiments of the present invention will now be described by referring to the drawings.

### Embodiment 1

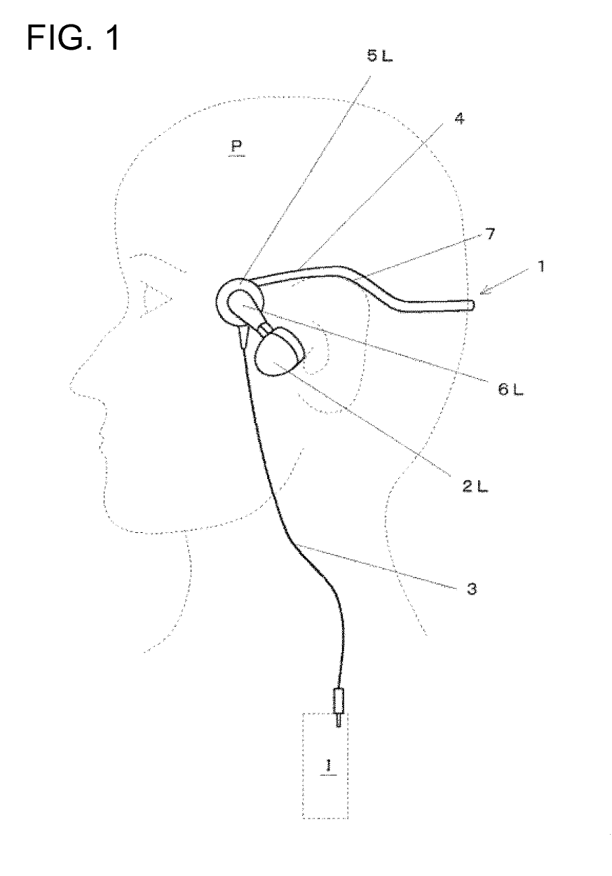

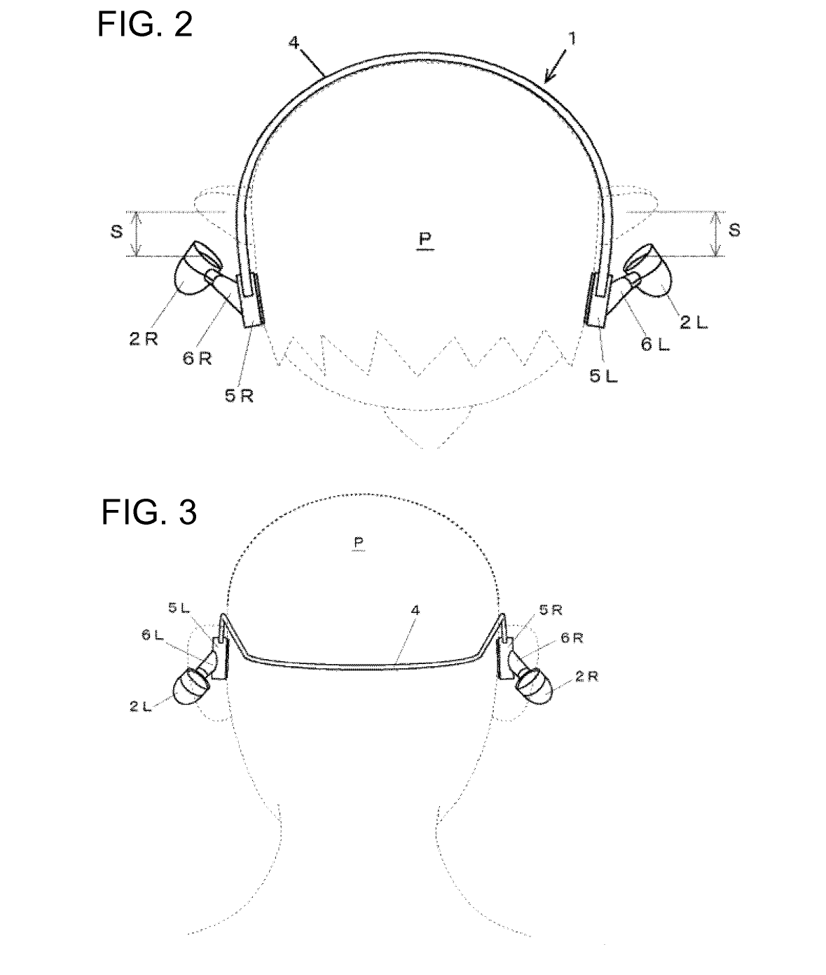

FIG. 1 to FIG. 3 each is an outside drawing each showing the situation where the user P puts on the ear speaker of Embodiment 1 of the present invention. FIG. 1 is a side view, FIG. 2 is a plane view, and FIG. 3 is a rear view.

The ear speaker of the present invention is connected to an output terminal of a sound device I such as a portable audio player, is worn to the head of the user P, and plays back music or such. Specifically, the ear speaker of the present invention is so-called headphone type speaker and possesses a head band 1, speakers 2R and 2L, and a connecting cable 3.

The head band 1 is worn to the user P at the position from the temporal regions to the back of the head, and possesses a band portion 4 having an arch form and wearing pads 5R and 5L. The wearing pads 5R and 5L are provided on the tips of the band portion 4, and are in contact with the both temporal regions of the user P to keep the wearing situation. At the outside portions of the wearing pads 5R and 5L, the speakers 2R and 2L are rotatably attached via arms 6R and 6L for mounting a speaker.

The band portion 4 is composed of a flexible and light weight material having elasticity such as a resin. On the band portion 4, the ear hook 7 to be put on the auricle of the user P is formed in the bent form. Due to the elasticity and the shape of the ear hooks 7, the head is sandwiched between the hooks, whereby the band portion 4 is worn to a portion from the temporal regions to the back of the head of the user P.

The wearing pads 5R and 5L are parts which are just in contact with a portion around the temple when the head of the user P is sandwiched by the band portion 4, and they are composed of a material having a little oppressive feeling such as sponge. This makes it possible to comfortably use the ear speaker over a long period.

The arms 6R and 6L for mounting speaker are provided so as to be directed downwardly from outside of the wearing pads 5R and 5L, and they are slanted and extended rearward of the wearing pads 5R and 5L in an outward opening manner. The speakers 2R and 2L are attached to both tips of the wearing pads 6R and 6L in a rotatable manner in the inner and outer directions, i.e., in the direction toward the ear hole and in the direction toward out of the ear holes.

A stereo connecting cable 3 is connected to the wearing pad 5L, which is one of the wearing pads. The connecting cable 3 is branched so that one of the branched cables is connected to the speaker 2L through the arm 6L for mounting a speaker, and the other of the branched cables is connected to the speaker 2R from the inside of the band portion 4 to the speaker 2L so that the stereo audio signals from the sound device I are branched the right side and the left side for outputting sound to both speakers 2R and 2L.

By such a configuration, when the head band 1 is worn to the head of the user P, the ear speaker is worn to the head of the user P from the temporal regions to the back of the head by the virtue of the elasticity of the band portion 4 and of the ear hooks 7. In addition, the wearing state is kept by the wearing pads 5R and 5L. The rotation of the speakers 2R and 2L are adjusted at the tips of the arms 6R and 6L for mounting a speaker, whereby the speakers 2R and 2L are directed at the both ear holes of the user P, respectively. Specifically, at this wearing state, the speakers 2R and 2L output sound from the position at a set distance S from the ear holes.

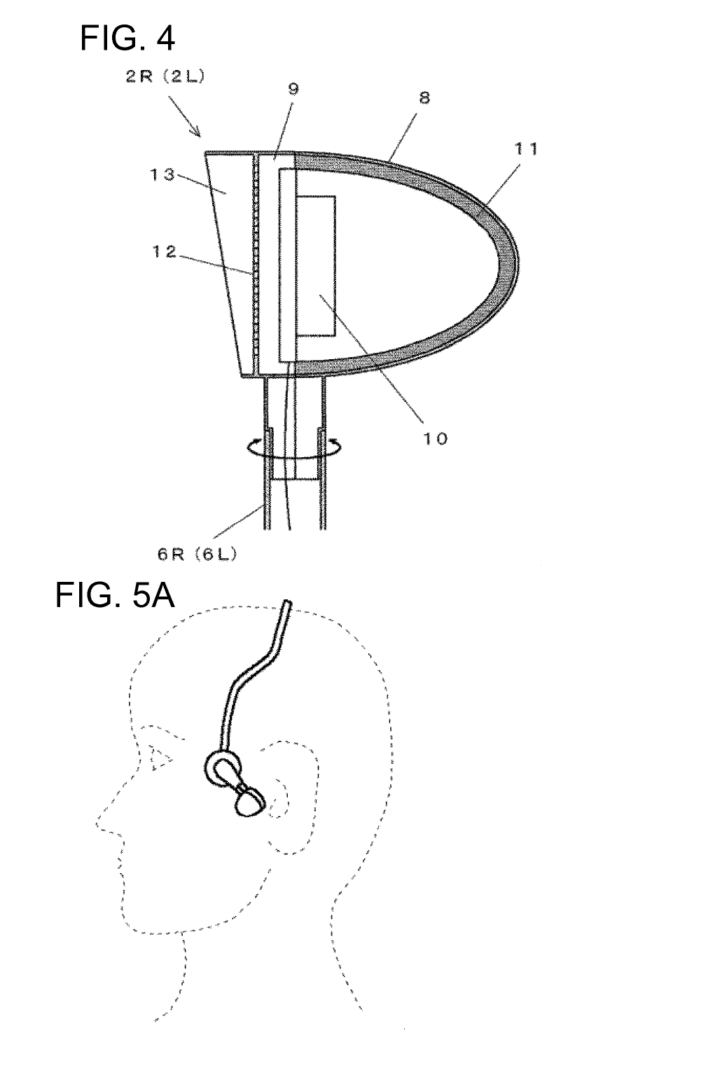

FIG. 4 is an inner cross-sectional view of the speaker portion.

The speakers 2R and 2L each has a housing 8 formed in a shape of a hemispheric form or a hemi-spheroidal form, and a disc shaped cover 9 mounted in front of the housing 8. A speaker unit 10, which converts an audio signal into playback sound, is attached to the front opening of the housing 8 with which the cover 9 is equipped.

A sound absorbing material 11 made of wool felt is adhered onto the inner surface of the housing 8. The sound absorbing material 11 prevents sound leakage to the outer surface of the housing 8. The inner state of the housing 8 is made so that echo of the sound is amplified. By such a configuration, the output of the sound from the speaker unit 10 is effectively radiated from the front side.

A front surface of the cover 9 has opened sound holes 12, and the peripheral portions of the cover 9 are projected relative to the front surface to form a hood 13. The hood 13 is formed so that the tip side becomes higher than the base side whereby the sound output from the speaker unit 10 is slightly directed toward the inside.

The speaker unit 10 plays back the audio signal from the sound device I connected to the connecting cable 3, and it is particularly preferable, if the speaker unit 10 has output characteristics of enhancing output of lower register, which is poor in directivity. By such a configuration, even if the audio signal is outputted from the speakers 2R and 2L, at a position a set distance S far from the ears, the user P can enjoy audio playback with a sufficient register.

Since the ear speaker of Embodiment 1 according to the present invention configured as described above output an audio signal at the position a set distance from the ear hole, the damage against the eardrum is drastically reduced in comparison with the conventional overhead type headphone that is put on so that auricle is covered, the ear fitting type headphone that is put on the auricle, and inner ear type headphone that is directly inserted in the ear hole. As a result, headphone deafness can be prevented by the ear speaker of the present invention. Also, since the surrounding sound can be heard even during the course of using the ear speaker, the ear speaker of the present invention can safety enjoy audio playback such as music playback.

Due to the wearing pads 5R and 5L, good fitting sense of the ear speaker can be obtained; the user P can use the ear speaker with less feeling of wrongness and tiredness. Also, the ear speaker is difficult to be slanted and tired even if it is put on over a long period of time. In addition, since the sound absorbing material is provided within the housing of the speaker, the sound leakage becomes small, and the sound wave reflected within the housing can be effectively radiated from the front surface.

The present invention is not restricted to the above embodiment, and various embodiments can be considered.

### Embodiment 2

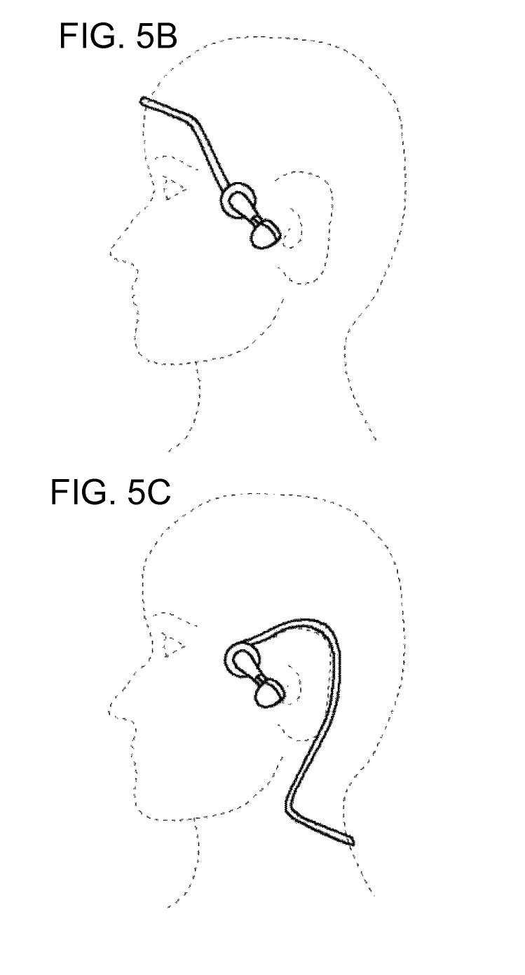

Embodiment 2 is the ear speaker of the present invention wherein the shape of the band portion is to be an overhead type to be worn to the user P at the position from the temporal regions to the back of the head (FIG. 5A).

### Embodiment 3

Embodiment 3 is the ear speaker of the present invention wherein the shape of the band portion is to be a type of spectacles to be worn to the user P at the position from the temporal regions to the front of the head (FIG. 5B).

### Embodiment 4

Embodiment 4 is the ear speaker of the present invention wherein the shape of the band portion is to be a neck type to be suspended on the neck (FIG. 5C).

### Embodiment 5

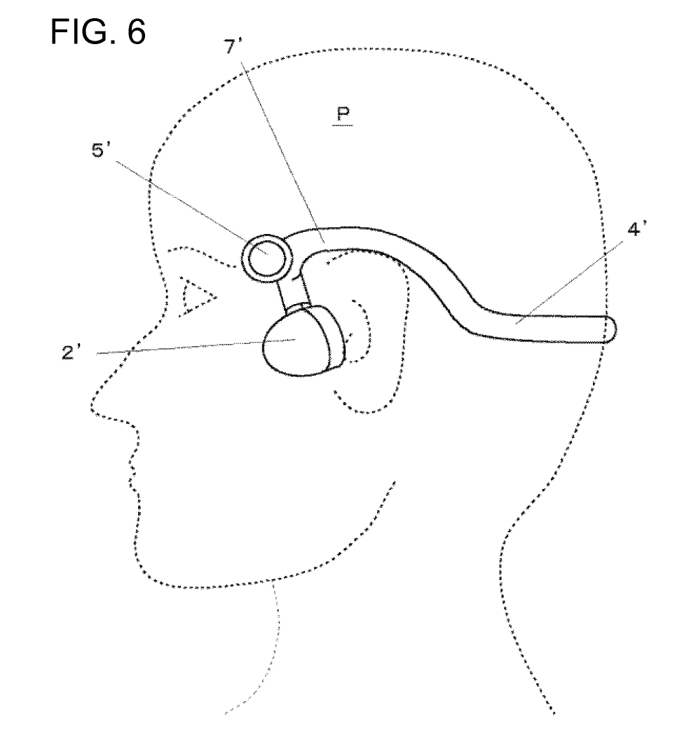

As shown in FIG. 6, the ear speaker is configured so that the tip of the band portion 4′ is bent to meet the shape of the ear to form the ear hook 7′, and the speaker 2′ is rotatably attached to the tip of the ear hook 7′ . In this case, the wearing pad 5′ is mounted on the bent portion of the ear hook 7′ to be in contact with a portion near the temple of the user P as in the above embodiment. By such a configuration, the ear speaker is worn to the head portion of the user P due to the elasticity of the band portion 4′ and communication to the ear hook 7′, and the ear speaker is kept wearing without any oppressive feeling.

### Description of Symbols

Head Band 1

2R, 2L Speakers

3 Connecting Cable

4 Band Portion

5R, 5L Wearing Pads

6R, 6L Arms for Mounting Speaker

7 Ear Hook

8 Housing

9 Cover

10 Speaker Unit

11 Sound Absorbing Material

12 Sound Holes

13 Hood

I Sound Device

P User

S Set Distance

1. An ear speaker having speakers which output an audio signal, and a mounting part mounted in a position at a set distance from the ear hole of the user, characterized in that the speakers are movably attached to the mounting part in such a manner that, when worn by the user, the speakers are directed at the both ear holes of the user, respectively.

2. The ear speaker according to claim 1, wherein said speaker has a bullet form as a whole, the rear portion of which forms a hemispheric form or a hemi-spheroidal form, and the front portion of which is a flat surface equipped with a hood, and sound holes are formed on the flat surface of the front portion, and a sound absorbing material is provided within the inside of the hemispheric or the hemi-spheroidal portion.

3. The ear speaker according to claim 1, wherein said mounting part has an arch form band portion which is fit to the head of the user, wearing pads which are provided on both tips of the mounting part, and which are in contact with right and left temporal regions of the user to keep the wearing state, and hear hooks which are fixed to the left and right auricles of the user.
